(19) United States
(12) Patent Application Publication
(10) Pub. No.: US 2017/0080816 A1
(43) Pub. Date: Mar. 23, 2017

(54) BATTERY CHARGING BASE AND RECHARGING METHOD IMPLEMENTING SUCH A BASE

(71) Applicant: SOFTBANK ROBOTICS EUROPE, PARIS (FR)

(72) Inventors: Vincent CLERC, CLAMART (FR); Nicolas GARCIA, PARIS (FR); Lucas SOUCHET, PARIS (FR); Vincent CHEVRY, PARIS (FR)

(21) Appl. No.: 15/310,720

(22) PCT Filed: Jun. 2, 2015
(86) PCT No.: PCT/EP2015/062198

§ 371 Date: Nov. 11, 2016

(30) Foreign Application Priority Data
Jun. 5, 2014 (FR) 1455102

(51) Int. Cl. B60L 11/18; G05D 1/02; B25J 19/00

(52) U.S. Cl. CPC B60L 11/1833; B60L 11/1816; B25J 19/005; G05D 1/0225; G05D 2201/0217

(57) ABSTRACT

A recharging assembly comprising a mobile vehicle and a recharging base of a form complementing the mobile vehicle and capable of receiving the mobile vehicle and intended to recharge a battery of a mobile vehicle comprising at least one wheel, the base connected to an electrical source, wherein the base comprises: a reception surface and a baseplate plane placed on a reference plane, the reception surface and the baseplate plane of the base forming an acute angle, a hemispherical cavity hollowed out in the reception surface to receive the at least one wheel, at least one electrical connector arranged to allow the connection of the base with the battery when the wheel is lowered into the hemispherical cavity. A recharging method implementing the recharging assembly is provided.

The invention relates to a recharging assembly comprising a mobile vehicle and a base for recharging a rechargeable battery of the mobile vehicle and applies notably to the field of robotics. The invention relates also to a method for recharging a rechargeable battery implementing such an assembly.

A mobile vehicle operating on battery requires, at a given moment, a recharge of its battery. A mobile vehicle can be, for example, a humanoid-type robot. A humanoid-type robot should be understood to be a robot with similarities with the human body. It can be the top of the body, or only an articulated arm ending in a clamp that can be likened to a human hand. In the present invention, the top of the body of the robot is similar to that of a human trunk. A humanoid robot can be more or less sophisticated. It can control its own balance statically and dynamically and walk on two limbs, possibly in three dimensions, or simply roll on a base. It can collect signals from the environment (sound, sight, touch, etc.) and react according to one or several more or less sophisticated behaviors, and interact with other robots or human beings, either by speech, or by gesture. For a current generation of humanoid robots, programmers are capable of creating scenarios, more or less sophisticated, like sequences of events affecting the robot and/or actions performed by the robot. These actions can be conditional on certain behaviors of people who interact with the robot. However, in these humanoid robots of the first generation, the application programming is done in a development tool and each application has to be launched by a trigger producing the occurrence included in the application.

In the field of humanoid robotics, there is therefore a need for a humanoid robot capable of living an “independent life”, as a human being does, which is capable of behaving in a determined manner, according to the environment in which it moves.

Generally, such a robot is supplied with electricity by one or more storage batteries, or, more commonly, one or more batteries. These are a set of electrical storage batteries linked together so as to create an electrical generator of desired voltage and capacity. The first aim of the battery is to provide the current and the voltage necessary to the movement of the robot. The battery can also be used to power the electronic apparatus embedded on the robot.

It is then necessary, at a given moment, to recharge the battery of the robot. Generally, a robot operating on battery is capable of moving as long as the battery is charged and becomes immobile when the charge thereof ends. An outside intervention is then required to, for example, place the robot on a battery recharging base. Some robots are capable of returning to their recharging base independently. They sometimes have difficulties in connecting to their recharging base, either because of poor positioning of the robot on its base, or because of poor contacts between the connectors of the robot and of the recharging base. Moreover, it happens, when the robot connects to its recharging base, that electrical arcs are created between the electrical connectors of the robot and of the recharging base, that can damage the robot and/or the base.

The invention aims to mitigate all or some of the abovementioned problems by proposing a recharging assembly comprising a mobile vehicle and a base for recharging a battery of the mobile vehicle, as well as a method implementing such an assembly, allowing any mobile vehicle such as a robot to recharge independently.

To this end, the subject of the invention is a recharging assembly comprising a mobile vehicle and a recharging base of a form complementing the mobile vehicle and capable of receiving the mobile vehicle and intended to recharge a battery of a mobile vehicle comprising at least one wheel, the base being able to be connected to an electrical source, characterized in that the base comprises:

a reception surface and a baseplate plane intended to be placed on a reference plane, the reception surface and the baseplate plane of the base forming an acute angle,

a hemispherical cavity hollowed out in the reception surface and intended to receive the at least one wheel,

at least one electrical connector arranged so as to allow the connection of the base with the battery when the at least one wheel is lowered into the hemispherical cavity.

According to one embodiment, the recharging base further comprises a presence connector of the mobile vehicle on the base so as to be activated after the connection of the electrical connector and of the battery.

According to one embodiment, the recharging base comprises a first key form positioned at the intersection between the reception surface and the baseplate plane, intended to form an abutment for a second wheel of the vehicle.

According to another embodiment, the recharging base comprises a guideway produced in the reception surface between the intersection of the reception surface and of the baseplate plane and the cavity, the guideway being intended to guide at least one wheel toward the cavity.

Advantageously, the guideway is configured to ensure a centering of the wheel about a main direction of the guideway, and the accuracy of the centering increases on approaching the cavity.

According to another embodiment, the cavity has a center and a pole, an axis Z passing through the center and the pole being substantially at right angles to the reference plane, and the base comprises a void passing through the base from the pole of the cavity and substantially parallel to the axis Z.

Advantageously, the connector comprises a mobile contact that is mobile in a direction substantially at right angles to the baseplate plane.

Advantageously, the base comprises a perimeter capable of closely following the forms of the mobile vehicle.

Another subject of the invention is a recharging method implementing a base as claimed in one of the preceding claims and a vehicle configured to be recharged on the base, characterized in that it comprises the following steps:

translation of the mobile vehicle over the reception surface,

insertion of the at least one wheel into the hemispherical cavity and simultaneous contacting of the connector of the base with the battery of the mobile vehicle.

Advantageously, the recharging method comprises a step of activation of the recharging of the battery comprising the following steps:

verification of the presence of the mobile vehicle on the recharging base by depression of the presence connector,

measurement of the voltage at the terminals of the battery and comparison of the measured voltage to a minimum voltage value and a maximum voltage value,

measurement of the internal resistance of the battery and comparison of the resistance to a minimum resistance value and a maximum resistance value.

The method can further comprise a step of abutment of the second wheel against the key form.

The method can comprise, first, a step of guiding of at least one wheel toward the cavity by means of the guideway.

The mobile vehicle is, for example, a robot. This robot has at least one wheel to allow its movement on a reference plane.

Alternatively, the mobile vehicle can be any type of vehicle having at least one wheel.

Another subject of the invention is a humanoid-type robot, comprising a recharging base according to the invention.

The invention will be better understood and other advantages will become apparent on reading the detailed description of an embodiment given by way of example, the description being illustrated by the attached drawing in which:

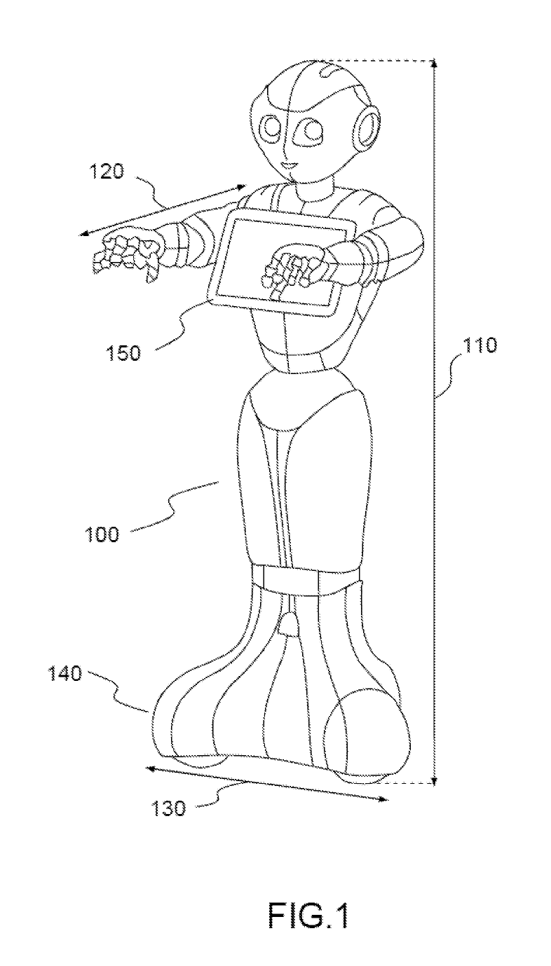

FIG. 1 represents a humanoid-type robot configured to be recharged on a recharging base according to the invention,

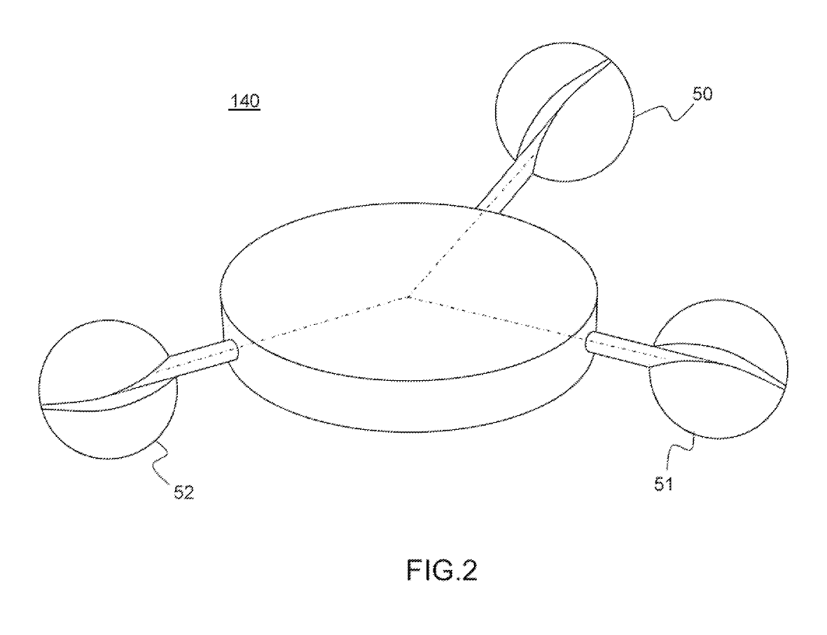

FIG. 2 represents an example of a base comprising wheels for a humanoid-type robot configured to be recharged on a recharging base according to the invention,

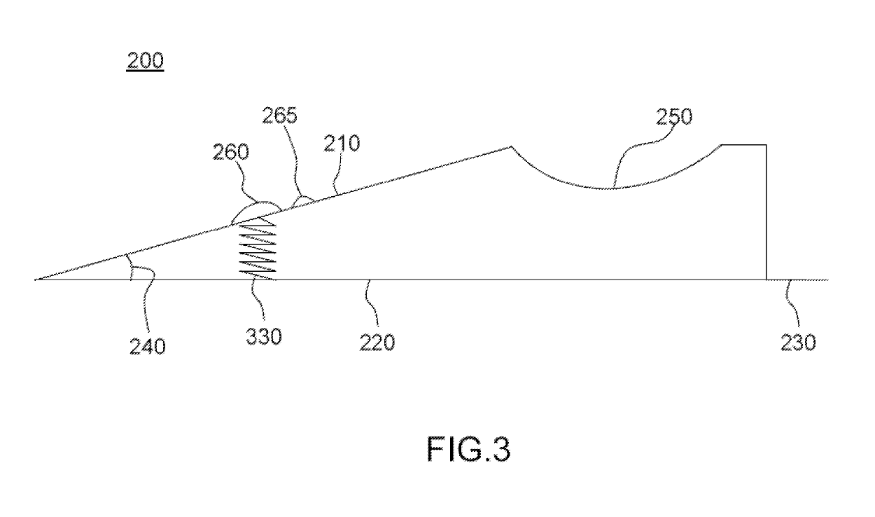

FIG. 3 schematically represents a cross-sectional view of a recharging base according to the invention,

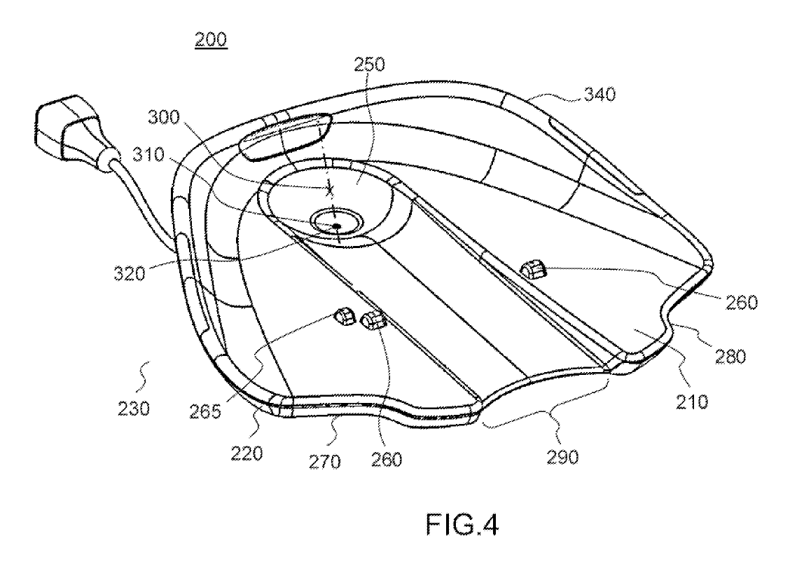

FIG. 4 represents a view of a recharging base according to the invention,

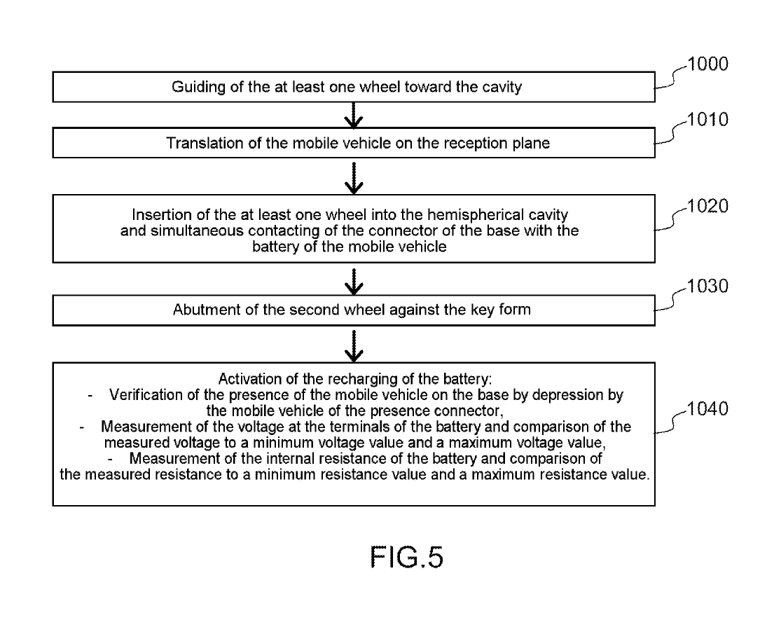

FIG. 5 schematically represents the steps of a recharging method according to the invention,

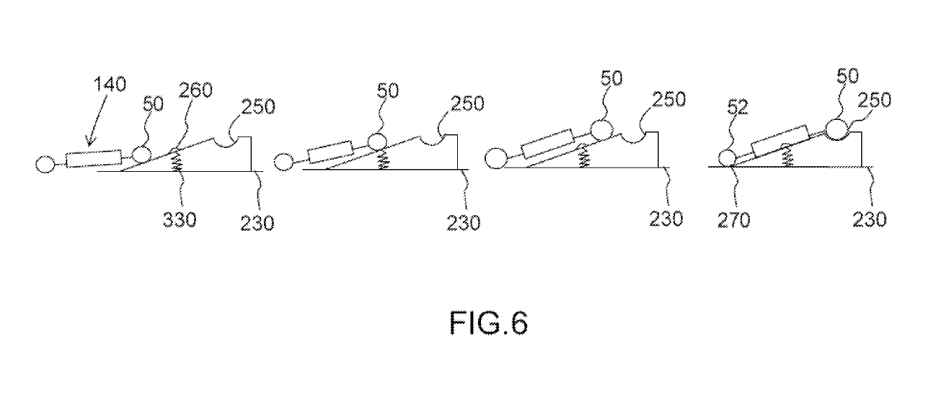

FIG. 6 schematically represents different steps during which a mobile vehicle joins with a recharging base according to the invention.

For clarity, the same elements will bear the same references in the different figures.

In the description, the invention is described with the example of a robot moving by means of at least one wheel. However, the invention is applicable to any other mobile vehicle having at least one wheel.

FIG. 1 represents a robot 100 of humanoid nature configured to be recharged on a recharging base according to the invention. The robot 100 in FIG. 1 is taken as an example of a humanoid robot configured to be recharged on a base according to the invention. The lower part of the robot 100 in FIG. 1 is not functional for walking, but can move in any direction on its baseplate 140 which rolls over the surface on which the robot 100 is located. In our example, the robot 100 has a height 110 which can be approximately 120 cm, a depth 120 of approximately 65 cm and a width 130 of approximately 40 cm. In a specific configuration, the robot has a tablet 150 with which it can communicate messages (audio, video, web pages) to its environment, or receive inputs from users through a touch interface of the tablet. In addition to the processor of the tablet, the robot also uses the processor of its own motherboard which can for example be an ATOM™ Z530 board from Intel™. Advantageously, the robot also has a processor dedicated to the flows of data between the motherboard and the boards supporting the magnetic rotary sensors, or magnetic rotary encoders, abbreviated MRE, and the sensors which control the motors of the articulations in a limb and the balls that the robot uses as wheels, in an embodiment of the invention. The motors can be of different types, depending on the amplitude of the maximum torque necessary for a defined articulation. For example, coreless brushed direct current motors from e-Minebea™ (SE24P2CTCA for example) can be used, or brushless direct current motors from Maxon™ (EC45_70W for example). The magnetic rotary encoders preferentially use the Hall effect, with 12 or 14 precision bits.

In embodiments of the invention, the robot illustrated in FIG. 1 also comprises different types of sensors. Some sensors are used to control the position and the movements of the robot. Such is the case, for example, of an inertial unit located in the torso of the robot and comprising a 3-axis gyrometer and a 3-axis accelerometer. The robot can also include two RGB color 2D cameras on the front of the robot (top and bottom) of the system-on-chip (SOC) type, like those from Shenzen V-Vision Technology Ltd™ (OV5640) with a resolution of 5 megapixels at 5 images per second and a field of view (FOV) of approximately 57° horizontal and 44° vertical. A 3D sensor can also be included behind the eyes of the robot, like the ASUS XTION™ SOC sensor with a resolution of 0.3 megapixels at 20 images per second, with approximately the same field of view as the 2D cameras. The robot can also be equipped with laser line generators, for example three at the head level and three in the base, so as to be able to detect its relative position in relation to objects and/or human beings in its environment. The robot can also include microphones to be able to detect sounds in its environment. In one embodiment, four microphones with a sensitivity of 300 mV/Pa+/−3 dB at 1 kHz and a frequency range of 300 Hz to 12 kHz (−10 dB relative to 1 kHz) can be located in the head of the robot. The robot can also include two sonar sensors, possibly positioned in front and behind its base, to measure the distance which separates it from objects and/or human beings in its environment. The robot can also include touch sensors, on its head and on its hands, to allow interactions with the human beings. It can also include shock absorbers on its base to protect it from obstacles that it encounters as it moves around.

To translate its emotions and communicate with the human beings in its environment, the robot can also include:

LEDs, or light-emitting diodes, for example in its eyes, its ears and on its shoulders;

loudspeakers, for example two of them, located in its ears.

The robot can communicate with a base or other robots through an RJ45 ethernet or 802.11 wifi connection.

The robot can be powered by a lithium iron phosphate battery with an energy of approximately 400 Wh or a trimix lithium polymer (lithium cobalt manganese) battery of approximately 860 Wh. The robot can access a recharging base suited to the battery type that it contains.

The position and the movements of the robot are controlled by its motors, by using algorithms which are activated by chains defined in each limb and effectors defined at the termination of each limb, taking into account the measurements from the sensors.

FIG. 2 represents an example of a baseplate 140 comprising wheels 50, 51, 52 for a humanoid-type robot configured to be recharged on a recharging base according to the invention. In the example represented in FIG. 2, the baseplate 140 comprises three wheels 50, 51, 52. In order to be configured to be recharged on a recharging base according to the invention, the baseplate 140 has to comprise at least one wheel 50. It can of course comprise several others.

FIG. 3 schematically represents a cross-sectional view of a base 200 of the recharging assembly according to the invention. The recharging base 200 is intended to recharge a battery of a mobile vehicle comprising at least one wheel 50. The base 200 can be connected to an electrical source. The base 200 comprises a reception surface 210 and a baseplate plane 220 intended to be placed on a reference plane 230. The reception surface 210 and the baseplate plane 220 form an acute angle 240. The base 200 comprises a hemispherical cavity 250 intended to receive the wheel 50. The base also comprises an electrical connector 260. The electrical connector 260 can for example be on the reception surface 210. The connector 260 comprises a mobile contact 330 in a direction substantially at right angles to the baseplate plane 220. The mobile contact 330 can be obtained by means of a spring or any other part having a certain elasticity.

The base 200 also comprises a presence connector 265 of the mobile vehicle on the base 200 so as to be activated after the connection of the electrical connector 260 and of the battery. The presence connector 265 has a degree of freedom in translation in a direction substantially at right angles to the baseplate plane 220. Thus, when the mobile vehicle takes its place on the recharging base 200 in order to recharge its battery, the presence connector 265 is translated under the weight of the mobile vehicle. In other words, the presence connector 265 is depressed into the reception surface 210 of the base 200 when the mobile vehicle is present on its base.

The electrical connector 260 and the presence connector 265 are slightly offset. Thus, when the wheel 50 is lowered into the hemispherical cavity 250, first of all, there is the electrical connection between the electrical connector 260 and the base 200. Then, only after the electrical connection, the presence connector 265 is activated, that is to say depressed, because of the presence of the mobile vehicle on the recharging base 200. The recharging is then performed. The depression of the presence connector 265 lastly makes it possible to avoid the formation of any electrical arc that can lead to damage to the parts. Conversely, once the recharging of the battery has been performed and at the moment when the mobile vehicle leaves its base, there is first of all disconnection of the presence connector 265, then generating an electrical disconnection. Then, there is disconnection of the electrical connector 260 of the mobile vehicle (that is to say a physical disconnection), since the mobile vehicle leaves the base 200.

FIG. 4 represents a view of the recharging base 200 according to the invention. The base 200 comprises a first key form 270 positioned at the intersection between the reception surface 210 and the baseplate plane 220. The first key form 270 is intended to form an abutment for a second wheel 52 of the mobile vehicle, in the case where the vehicle comprises two wheels. In the case where the vehicle comprises three wheels 50, 51, 52 as illustrated in FIG. 2, the base 200 comprises a second key form 280, this one also intended to form an abutment for the third wheel 51 of the mobile vehicle.

The base 200 comprises a guideway 290 produced in the reception surface 210 between the intersection of the reception surface 210 and of the baseplate plane 220 and the cavity 250. The guideway 290 is intended to guide the wheel 50 toward the cavity 250.

The base 200 allows for a good placement of the mobile vehicle for its recharging on the base 200. In the case of a mobile vehicle comprising three wheels 50, 51, 52, the wheel 50 is inserted into the guideway 290 which makes it possible to guide the wheel 50 toward the hemispherical cavity 250 of the recharging base 200. In other words, the guideway 290 is configured to ensure a centering of the wheel 50 about a main direction of the guideway 290, and the accuracy of the centering increases on approaching the cavity 250. In its translation over the reception surface 210, the wheel 50 is guided by the guideway 290, ideally at the center thereof. When the wheel 50 makes contact with the hemispherical cavity 250, the wheel 50 follows the line of greatest slope of the cavity in order for the wheel 50 to take position at the center of the hemispherical cavity 250. In other words, the trajectory of the wheel 50 corresponds to a rise toward the hemispherical cavity 250 then a redescent into the hemispherical cavity 250. The insertion of the wheel 50 into the cavity 250 takes place simultaneously with the contacting of the electrical connector 260 with the battery of the mobile vehicle.

The wheel 50 is inserted into the cavity 250. The degree of freedom in translation of the mobile vehicle is blocked. The wheels 51, 52 come into abutment against the key forms 270, 280. The degree of freedom in rotation of the mobile vehicle is blocked. Thus, the mobile vehicle is perfectly placed on its recharging base 200. The electrical connector 260 of the base 200 is then in contact with an electrical connector of the mobile vehicle to ensure the recharging of the battery of the mobile vehicle. In FIG. 4, two connectors 260 are represented. The base 200 according to the invention can comprise just one or more than two thereof.

The cavity 250 has a center 300 and a pole 310, an axis Z passing through the center 300 and the pole 310 being substantially at right angles to the reference plane 230. The base 200 comprises a void 320 passing through the base 200 from the pole 310 of the cavity 250 and substantially parallel to the axis Z. The void 320 makes it possible to discharge water or any other liquid substance accumulated in the cavity 250, directly or indirectly via the wheel 50.

The base 200 comprises a perimeter 340 capable of closely following the forms of the mobile vehicle. Thus, once placed on its recharging base 200, the mobile vehicle is well held by its base. And the perimeter 340 is also a means of ensuring that it is indeed a mobile vehicle corresponding to the base which has come to be recharged.

FIG. 5 schematically represents the steps of a recharging method according to the invention. According to the invention, the recharging method comprises the following steps:

guiding of at least one wheel 50 toward the hemispherical cavity 250,

translation of the mobile vehicle on the reception surface 210,

insertion of at least one wheel 50 into the hemispherical cavity 250 and simultaneous contacting of the connector 260 of the base with the battery of the mobile vehicle,

abutment of the second wheel 52 of the vehicle against the key form 270.

The method further comprises a step of activation of the recharging comprising the following steps:

verification of the presence of the mobile vehicle on the base 200 by depression by the mobile vehicle of the presence connector 265,

measurement of the voltage at the terminals of the battery and comparison of the measured voltage to a minimum voltage value and a maximum voltage value,

measurement of the internal resistance of the battery and comparison of the measured resistance to a minimum resistance value and a maximum resistance value.

For the recharging of the battery to be able to be activated, it is essential for the abovementioned three steps to be performed. It is therefore necessary to check that the mobile vehicle is well positioned on its base. This is verified when the presence connector 265 is depressed. Since the base is of a form complementing the mobile vehicle and it comprises a perimeter which closely follows the forms of the mobile vehicle, this step ensures the presence of a mobile vehicle accredited for this recharging base.

Furthermore, it is essential for the voltage at the terminals of the battery to be located between a minimum voltage value and a maximum voltage value that are predefined. For example, for a battery of 25.4 V nominal voltage, the voltage measured at the terminals of the battery must be located between 17 and 26V.

Finally, it is essential for the internal resistance of the battery to lie between a minimum resistance value and a maximum resistance value that are predefined. This value is a few tens of milliohms. It can be stressed that the internal resistance of the human body is a few kiloohms. This measurement therefore constitutes a safety measure to avoid any circulation of a current in the case where a human body would be positioned on the recharging base.

When these three conditions are fulfilled, the recharging is then activated.

FIGS. 6a, 6b, 6c, 6d schematically represent different steps during which a mobile vehicle rejoins a recharging base according to the invention. To lighten the figures, only the baseplate 140 of the mobile vehicle has been represented.

In FIG. 6a, the mobile vehicle approaches its recharging base 200. To detect its base 200, the vehicle can comprise an obstacle detection device comprising at least one electromagnetic beam emitter capable of forming a virtual plane that can intersect with the obstacle, at least one image sensor capable of producing an image of the intersection of the virtual plane and of the obstacle, an image analysis means capable of determining the obstacle, configured to compare the image with a reference image.

More specifically, the detection device can comprise a first so-called horizontal emitter of a first horizontal beam extending in a first virtual plane substantially parallel to the reference plane and the first image sensor capable of producing an image of the intersection of the first virtual plane and of the obstacle.

With the mobile vehicle having a preferred direction of movement in a first direction according to an axis X, the first virtual plane forms an angular segment about the axis X, and the obstacle detection device further comprises a second so-called horizontal emitter of a second horizontal beam extending in a second virtual plane in a first direction, forming an angular segment about an axis Y at right angles to the axis X and substantially parallel to the reference plane. The obstacle detection device comprises a second image sensor capable of producing an image of the intersection of the second virtual plane and of the obstacle. The device comprises a third so-called horizontal emitter of a third horizontal beam extending in a third virtual plane in a second direction, opposite the first direction, forming an angular segment about the axis Y and substantially parallel to the reference plane. The obstacle detection device comprises a third image sensor capable of producing an image of the intersection of the third virtual plane and of the obstacle.

The first, second and third so-called horizontal emitters are positioned on the mobile vehicle at a certain height from the reference plane. The virtual planes formed respectively by the emitters can intersect with an obstacle situated at a height greater than the height or with an obstacle of which a part is situated level with the virtual planes. The emitters allow for an obstacle detection that can be qualified as panoramic detection.

The image sensor can also be a so-called “wide angle” image sensor allowing it a single shot of the three horizontal virtual planes.

The obstacle detection device comprises a so-called spade emitter of a spade-like beam extending in a virtual plane configured to intersect with the reference plane according to a straight line at right angles to the axis X. The first image sensor is capable of producing an image of the straight line resulting from the intersection of the virtual plane and of the reference plane. The virtual plane formed by the emitter can intersect with an obstacle situated at a height corresponding to the distance between the virtual plane and the reference plane. It can be an obstacle placed on the reference plane of large size or of small size. A hole or a doorstop can notably be cited as examples of obstacles.

The obstacle detection device comprises a first so-called oblique emitter of a first oblique beam extending in a first oblique virtual plane in the first direction according to the axis X and secant to the reference plane. The obstacle detection device comprises a second so-called oblique emitter of a second oblique beam extending in a second oblique virtual plane in the first direction according to the axis X and secant to the reference plane. The first image sensor is capable of producing an image about the intersection of the oblique virtual planes with the reference plane.

The oblique beams can intersect with small obstacles, holes, or obstacles of larger size, with which the horizontal beams might not necessarily have intersected.

Thus, the six beams allow the obstacle detection device to form an intersection with virtual planes and any obstacle located in a near environment. In the case of the recharging base 200, the intersection between the virtual planes and the base 200 will form a known accurate image of the mobile vehicle. Thus, the mobile vehicle will detect the base 200 and will be able to be directed thereto in order to perform the recharging of its battery.

The wheel 50 is guided toward the cavity 250 by means of the guideway 290. The guideway presents the particular feature of forming a loose centering at the level of the intersection between the baseplate plane 220 and the reception surface 210. Thus, the wheel 50 can be translated over the reception surface 210 in the direction of the guideway 290, even if the mobile vehicle is not perfectly centered with the base 200. The closer the guideway 290 is to the cavity 250, the more refined the centering becomes. Thus, at the end of translation of the mobile vehicle on the reception surface 210, the mobile vehicle is perfectly positioned on its base 200.

During the translation of the mobile vehicle over the reception surface 210, as represented in FIG. 6b, the baseplate 140 passes over the connector 260, avoiding any scraping or friction between the baseplate 140 and the connector 260. Thus, the connector is not damaged. Furthermore, that makes it possible to avoid the creation of an electrical arc between the connectors of the base 200 and of the vehicle.

It should be noted that FIG. 6b is a cross-sectional view, the wheel 50 is translated in the guideway 290 and does not touch the connector 260, placed outside of the guideway 290.

The translation of the mobile vehicle toward the cavity 250 continues (see FIG. 6c). Finally, the wheel 50 is inserted into the cavity 250 by following the line of greatest slope of the cavity 250, the wheel 52 then comes into abutment against the key form 270, and the connector 260 of the base 200 then simultaneously makes contact with the positive and negative electrical poles of the battery of the mobile vehicle under the dual action of the lowering into the cavity and the end of the translation along the longitudinal axis of the guideway 290. The mobile vehicle is then perfectly positioned on its recharging base 200. The good contact between the connector 260 and the battery is promoted by the dual action of the mobile contact 330 and of the pressure exerted by the action of gravity on the mobile vehicle. It should be noted that the direction of placement of the mobile vehicle on the connector 260 is different from a translation along the reference plane. The mobile vehicle is placed on the connector 260 according to a translation substantially at right angles to the reference plane. That has the advantage of performing a contacting of the connector 260 with the battery (more specifically with the terminals of the battery) precisely at the moment when the recharging can begin, in order to avoid any friction upon the contact, and also avoid the formation of electrical arcs upon the separation of the battery of the mobile vehicle and of the base 200.

1. A recharging assembly comprising a mobile vehicle and a recharging base of a form complementing the mobile vehicle and capable of receiving the mobile vehicle and intended to recharge a battery of a mobile vehicle comprising at least one wheel, the base being able to be connected to an electrical source, wherein the base comprises:
a reception surface and a baseplate plane intended to be placed on a reference plane, the reception surface and the baseplate plane of the base forming an acute angle,
a hemispherical cavity hollowed out in the reception surface and intended to receive the at least one wheel,
at least one electrical connector arranged so as to allow the connection of the base with the battery when the at least one wheel is lowered into the hemispherical cavity,
wherein the reception surface comprises a guideway produced in the reception surface between the intersection of the reception surface and of the baseplate plane and the cavity, the guideway being intended to guide the at least one wheel toward the cavity.

2. The recharging assembly as claimed in claim 1, wherein the base further comprises a presence connector of the mobile vehicle on the base so as to be activated after the connection of the electrical connector and of the battery.

3. The recharging assembly as claimed in claim 1, wherein the base comprises a first key form positioned at the intersection between the reception surface and the baseplate plane, intended to form an abutment for a second wheel of the vehicle.

4. The recharging assembly as claimed in claim 1, wherein the guideway is configured to ensure a centering of the wheel about a main direction of the guideway, and wherein the accuracy of the centering increases on approaching the cavity.

5. The recharging assembly as claimed in claim 1, wherein the cavity has a center and a pole, an axis Z passing through the center and the pole being substantially at right angles to the reference plane, and wherein the base comprises a void passing through the base from the pole of the cavity and substantially parallel to the axis Z.

6. The recharging assembly as claimed in claim 1, wherein the connector comprises a mobile contact that is mobile in a direction substantially at right angles to the baseplate plane.

7. The recharging assembly as claimed in claim 1, comprising a perimeter capable of closely following the forms of the mobile vehicle.

8. A recharging method implementing a recharging assembly as claimed in claim 2, comprising the following steps:
guiding of the at least one wheel toward the cavity by means of the guideway,
translation of the mobile vehicle over the reception surface,
insertion of the at least one wheel into the hemispherical cavity and simultaneous contacting of the electrical connector of the base with the battery of the mobile vehicle.

9. The recharging method as claimed in claim 8, further comprising a step of activation of the recharging comprising the following steps:
verification of the presence of the mobile vehicle on the base by depression by the mobile vehicle of the presence connector,
measurement of the voltage at the terminals of the battery and comparison of the measured voltage to a minimum voltage value and a maximum voltage value,
measurement of the internal resistance of the battery and comparison of the measured resistance to a minimum resistance value and a maximum resistance value.

10. A recharging method implementing an assembly as claimed in claim 2, further comprising a step of abutment of the second wheel against the key form.
